(19) United States
(12) Patent Application Publication
(10) Pub. No.: US 2006/0098016 A1
(43) Pub. Date: May 11, 2006

(54) Motherboard

(76) Inventors: Hung-Hsiang Chou, Taipei (TW); Chuan-Te Chang, Taipei (TW)

Correspondence Address: RABIN & Berdo, PC, 1101 14TH STREET, NW, SUITE 500, WASHINGTON, DC, 20005, US

(21) Appl. No.: 11/183,885

(22) Filed: Jul. 19, 2005

(30) Foreign Application Priority Data
Nov. 8, 2004 (TW) 93217846

(51) Int. Cl. G06T 1/00

(52) U.S. Cl. 345/501

(57) ABSTRACT

A motherboard having a first transmission mode and a second transmission mode includes a chipset, a first graphic interface, a second graphic interface, a Small-Outline Dual-inside Memory Modules (SO-DIMM) connector, and an adapter. The SO-DIMM connector is connected with the chipset, the first graphic interface and the second graphic interface respectively. The adapter is electrically connected with the SO-DIMM connector, for shifting the first transmission mode and the second transmission mode. The first transmission mode is entered when the SO-DIMM connector and the adapter are electrically connected with the chipset and the first graphic interface while the second transmission mode is entered when the SO-DIMM connector and the adapter are electrically connected with the chipset, the first graphic interface and the second graphic interface.

This application claims the benefit of Taiwan application Serial No. 93217846, filed Nov. 8, 2004, the subject matter of which is incorporated herein by reference.

### BACKGROUND OF THE INVENTION

1. Field of the Invention

The invention relates in general to a motherboard, and more particularly to a motherboard having at least two graphic interfaces.

2. Description of the Related Art

In view of the increasing demand for the bandwidth of the graphic card, the graphic interface has been developed from AGP 8X interface to PCI Express X16 interface so that the bandwidth increases from 2.11 Gbyte/sec to 8 Gbyte/sec. The feature of PCI Express X16 interface lies in that the number of lanes for connection is adjustable. That is, PCI Express X16 interface is able to provide sixteen lanes but also provides other number of lanes. For example, PCI Express X16 interface can be regarded as PCI Express X8 interface to provide eight lanes, PCI Express X4 interface to provide four lanes, or PCI Express X1 interface to provide one lane.

Referring to FIG. 1, a block diagram of a graphic interface according to the prior art is shown. The graphic interface includes a chip 120, a socket 130, and a channel 110. One end of the channel 110 has several chipset lanes and the other end of the channel 110 has several socket lanes. The socket 130 includes several leads for being connected with a graphic card 140. When the transmission interface of the graphic card 140 is PCI Express X16 graphic interface, the system operates under sixteen lanes mode. Meanwhile, the sixteen chipset lanes of the chipset 120 from lane 0 to lance 15 are correspondingly connected to the sixteen socket lanes of the socket 130. However, if the bandwidth of the graphic card 140 for usage is 4 Gbyte/sec., PCI Express X16 interface of the graphic card 140 will be regarded as PCI Express X8 interface even though the graphic card 140 is connected to all the leads of the socket 130.

### SUMMARY OF THE INVENTION

It is therefore an object of the invention to provide a motherboard having transmission modes shiftable on user's demand so as to increase the flexibility of usage and enhance the operation performance.

The invention achieves the above-identified object by providing a motherboard having a first transmission mode and a second transmission mode. The motherboard includes a chipset, a first graphic interface, a second graphic interface, a Small-Outline Dual-Inside Memory Modules (SO-DIMM) connector, and an adapter. The SO-DIMM connector is connected with the chipset, the first graphic interface and the second graphic interface respectively. The adapter is electrically connected with the SO-DIMM connector, for shifting the first transmission mode and the second transmission mode. The first transmission mode is entered when the SO-DIMM connector and the adapter are electrically connected with the chipset and the first graphic interface, and the second transmission mode is entered when the SO-DIMM connector and the adapter are electrically connected with the chipset, the first graphic interface and the second graphic interface.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a graphic interface according to the prior art.

FIG. 2 is a block diagram showing a motherboard according to a preferred embodiment of the invention under a first transmission mode.

FIG. 3 is a block diagram showing a motherboard according to the preferred embodiment of the invention under a second transmission mode.

FIG. 4A shows an adapter electrically connected with a SO-DIMM connector according to a preferred embodiment of the invention under the first transmission mode.

FIG. 4B shows an adapter electrically connected with a SO-DIMM connector according to a preferred embodiment of the invention under the second transmission mode.

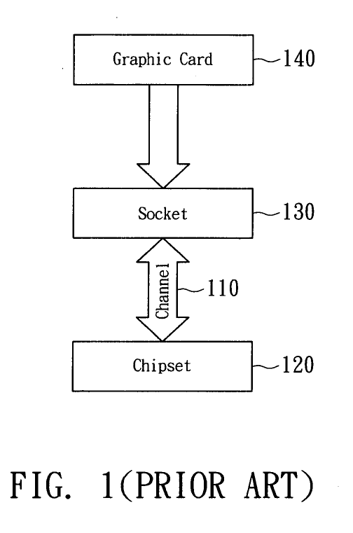

### DETAILED DESCRIPTION OF THE INVENTION

The motherboard of the invention provides dual-mode operation, which includes first and second transmission modes. According to a preferred embodiment of the invention, the motherboard has a graphic interface with N lanes under the first transmission mode and has two graphic interfaces with lanes add up to N. under the second transmission mode.

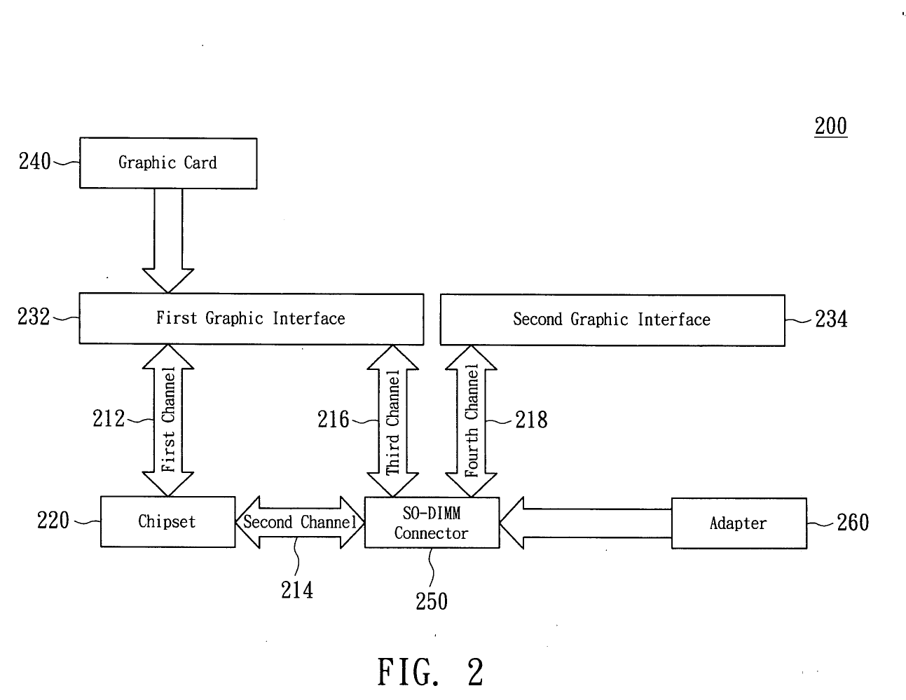

Referring to FIG. 2, a motherboard according to a preferred embodiment of the invention under a first transmission mode is shown. The motherboard 200 comprises a chipset 220, a first graphic interface 232, a second graphic interface 234, a Small-Outline Dual-Inside Memory Modules (SO-DIMM) connector 250, and an adapter 260. The first graphic interface 232 is connected with the chipset 220. The SO-DIMM connector 250 is connected with the chipset 220, the first graphic interface 232 and the second graphic interface 234 respectively. The chipset 220 has N lanes including M1 chipset front lanes and M2 chipset back lanes adjacent thereto. The first graphic interface 232 also has N lanes including M1 first-graphic-interface front lanes and M2 first-graphic-interface back lanes adjacent thereto. M1 and M2 add up to N, and M1 and M2 can be different. For example, the chipset 220 has sixteen lanes including eight chipset front lanes (lane 0˜lane 7) and eight chipset back lanes (lane 8˜lane 15). The first graphic interface 232 also has sixteen lanes including eight first-graphic-interface front lanes (lane 0˜lane 7) and eight first-graphic-interface back lanes (lane 8˜lane 15).

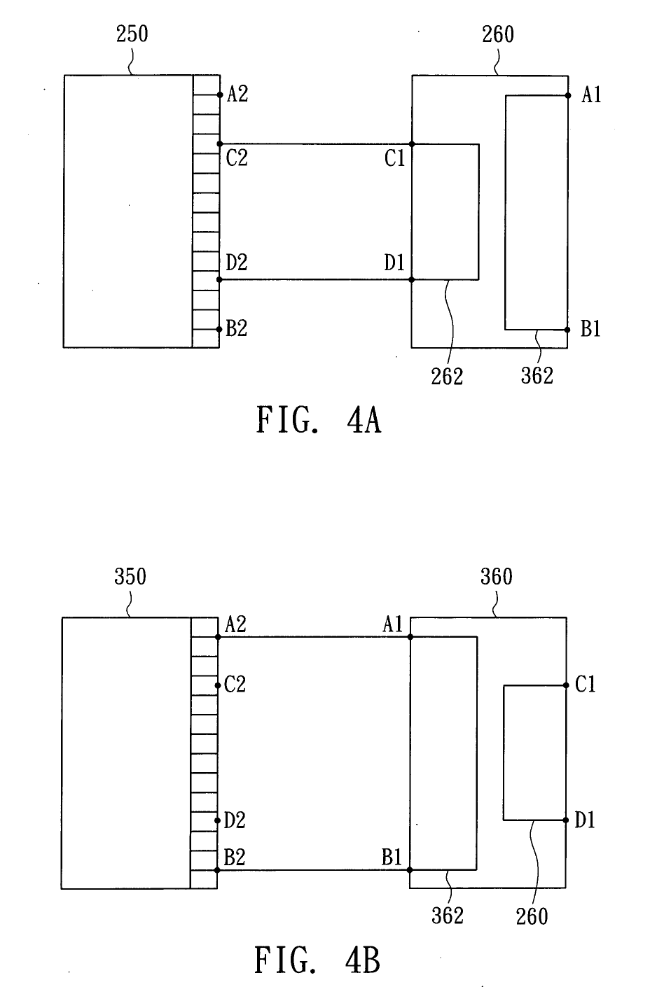

The adapter 260 is electrically connected with the SO-DIMM connector 250, for shifting the first transmission mode and the second transmission mode. The adapter 260 preferably includes two circuits for determining two paths and can be an adapter card. Referring to FIG. 4A, the adapter 260 is electrically connected with the SO-DIMM connector 250 under the first transmission mode. For the purpose of clear illustration, only single transmission circuit line is shown in FIG. 4A although each lane has its corresponding transmission circuit line. The adapter 260 includes a first circuit 262 and a second circuit 362. As shown in FIG. 4A, the adapter 260 is electrically connected with the SO-DIMM connector 250 by way of the first circuit 262 so that the motherboard enters the first transmission mode. The trace of the first circuit 262 has a contact C1 and a contact D1, which are respectively connected to a contact C2 and a contact D2 of the SO-DIMM connector 250. Since each lane has four traces, the preferred circuit with eight lanes requires thirty-two traces. Further, each trace has two contacts, the description of the electrical connection between the SO-DIMM connector 250 and other traces is omitted without given unnecessary details.

As shown in FIG. 2, the motherboard 200 further includes a first channel 212, a second channel 214, a third channel 216, and a fourth channel 218. The first channel 212 is between the chipset 220 and the first graphic interface 232, for electrically connecting the chipset 220 and the first graphic interface 232. One end of the first channel 212 is the chipset front lane while the other end of the first channel 212 is the first-graphic-interface front lane. The second channel 214 is between the chipset 220 and the SO-DIMM connector 250, for electrically connecting the chipset 220 and the SO-DIMM connector 250. One end of the second channel 214 is the chipset back lane while the other end of the second channel 214 is SO-DIMM connector 250. The third channel 216 is between the SO-DIMM connector 250 and the first graphic interface 232, for electrically connecting the SO-DIMM connector 250 and the first graphic interface 232. One end of the third channel 216 is the SO-DIMM connector 250 while the other end of the third channel 216 is the first-graphic-interface back lane.

When the adapter 260 is electrically connected with the SO-DIMM connector 250 by way of the first circuit 262, the first channel, the second channel, and the third channel are electrically connected so that the motherboard 200 enters the first transmission mode. Under the first transmission mode, the first-graphic-interface front lanes of the first graphic interface 232 are electrically connected to the chipset front lanes of the chipset 220 via the first channel 212 while the first-graphic-interface back lanes of the first graphic interface 232 are electrically connected to the chipset back lanes of the chipset 220 via the second channel 214, SO-DIMM connector 250 and the third channel 216. Under the first transmission mode, N lanes of the first graphic interface 232 are connected to N lanes of the chipset 220 one by one to form a graphic interface with N lanes. Therefore, the motherboard 200 provides the first graphic interface 232 for being inserted with one graphic card 240. The first graphic interface preferably is a PCI Express X16 graphic interface. Preferably, the first-graphic-interface front lanes are from lane 0 to lane 7 and the first-graphic-interface back lanes are from lance 8 to lane 15. The first channel 212 has eight traces, the second channel 214 has eight traces, and the third channel 216 has eight traces.

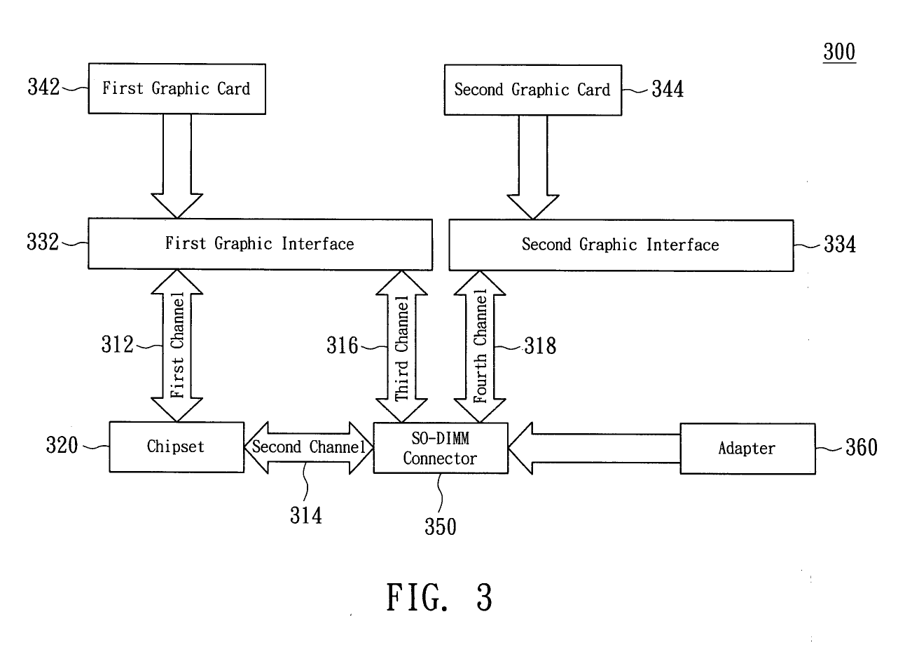

Referring to FIG. 3, a motherboard according to a preferred embodiment of the invention under a second transmission mode is shown. The motherboard 300 includes a chipset 320, a first graphic interface 332, a second graphic interface 334, a Small-Outline Dual-Inside Memory Modules (SO-DIMM) connector 350, and an adapter 360. The first graphic interface 332 is connected with the chipset 320. The SO-DIMM connector 350 is connected with the chipset 320, the first graphic interface 332 and the second graphic interface 334 respectively. The chipset 320 has N lanes including M1 chipset front lanes and M2 chipset back lanes adjacent thereto. The first graphic interface 332 also has N lanes including M1 first-graphic-interface front lanes and M2 first-graphic-interface back lanes adjacent thereto. M1 and M2 add up to N, and M1 and M2 can be different. For example, the chipset 320 has sixteen lanes including eight chipset front lanes (lane 0˜lane 7) and eight chipset back lanes (lane 8˜lane 15). The first graphic interface 332 also has sixteen lanes including eight first-graphic-interface front lanes (lane 0˜lane 7) and eight first-graphic-interface back lanes (lane 8˜lane 15).

The adapter 360 is electrically connected with the SO-DIMM connector 350, for shifting the first transmission mode and the second transmission mode. The adapter 360 preferably includes two circuits for determining two paths. Referring to FIG. 4B, the adapter 360 is electrically connected with the SO-DIMM connector 350 under the second transmission mode. For the purpose of clear illustration, only single transmission circuit line is shown in FIG. 4B although each lane has its corresponding transmission circuit line. The adapter 360 includes a first circuit 262 and a second circuit 362. As shown in FIG. 4B, the adapter 360 is electrically connected with the SO-DIMM connector 350 by way of the second circuit 362 so that the motherboard enters the second transmission mode. The trace of the second circuit 362 has a contact A1 and a contact B1, which are respectively connected to a contact A2 and a contact B2 of the SO-DIMM connector 350. Since each lane has four traces, the preferred circuit with eight lanes requires thirty-two traces. Further, each trace has two contacts; the description of the electrical connection between the SO-DIMM connector 350 and other traces is omitted without given unnecessary details. Referring both to FIGS. 4A and 4B, the adapters 260 and 360 can be the same card having two kinds of circuit disposed on opposite surfaces. That is, the reversed adapter 260 in FIG. 4A can be the adapter 360 in FIG. 4B. Therefore, the transmission mode can be determined by the circuit connection between the adapter and the SO-DIMM connector.

As shown in FIG. 3, the motherboard 300 further includes a first channel 312, a second channel 314, a third channel 316, and a fourth channel 318. The first channel 312 is between the chipset 320 and the first graphic interface 332, for electrically connecting the chipset 320 and the first graphic interface 332. One end of the first channel 312 is the chipset front lane while the other end of the first channel 312 is the first-graphic-interface front lane. The second channel 314 is between the chipset 320 and the SO-DIMM connector 350, for electrically connecting the chipset 320 and the SO-DIMM connector 350. One end of the second channel 314 is the chipset back lane while the other end of the second channel 314 is SO-DIMM connector 350. The third channel 316 is between the SO-DIMM connector 350 and the first graphic interface 332, for electrically connecting the SO-DIMM connector 350 and the first graphic interface 332. One end of the third channel 316 is the SO-DIMM connector 350 while the other end of the third channel 316 is the first-graphic-interface back lane. The fourth channel 318 is between the SO-DIMM connector 350 and the second graphic interface 334, for electrically connecting the SO-DIMM connector 350 and the second graphic interface 334.

When the adapter 360 is electrically connected with the SO-DIMM connector 350 by way of the second circuit 362, the first channel, the second channel, and the fourth channel are electrically connected so that the motherboard 300 enters the second transmission mode. Under the second transmission mode, the first-graphic-interface front lanes of the first graphic interface 332 are electrically connected to the chipset front lanes of the chipset 320 via the first channel 312 to form one graphic interface with the channels. Meanwhile, the first-graphic-interface back lanes of the first graphic interface 332 are electrically connected to the chipset back lanes of the chipset 320 via the second channel 314, SO-DIMM connector 350 and the fourth channel 318. Therefore, M1 lanes of the first graphic interface 332 are connected to M1 lanes of the chipset 320 one by one to form one graphic interface with M1 lanes, and M2 lanes of the second graphic interface 334 are connected to M2 lanes of the chipset 320 one by one to form the other graphic interface with M2 lanes, wherein M1 and M2 add up to N. Under the second transmission mode, the motherboard 300 provides the first graphic interface 332 for being inserted with a first graphic card 342 and the second graphic interface 334 for being inserted with a second graphic card 344. The first and second graphic interfaces 332 and 334 preferably are PCI Express X16 graphic interfaces since the number of lanes of PCI Express X16 interface in use is adjustable. Under the second transmission mode, both of the first and second graphic interfaces 332 and 334 preferably provide eight lanes for being regarded as PCI Express X8 even though PCI Express X16 interface is able to provide sixteen lanes. Preferably, the first-graphic-interface front lanes are from lane 0 to lane 7 and the second-graphic-interface front lanes are from lane 8 to lane 15. The first channel 212 has eight traces, the second channel 214 has eight traces, and the fourth channel 218 has eight traces. In particular, parallel processing of two graphic interfaces enhances the operation efficiency. Parallel processing means one frame is processed by two graphic cards; the upper portion of the frame is processed by the first graphic card 342 and the lower portion of the frame is processed by the second graphic card 344. According to the experimental data, the operation performance of two PCI Express X8 graphic interfaces is seventy-eight percentage higher than that of one PCI Express X16 graphic interface.

Furthermore, the second graphic interface, the second graphic cards, and the fourth channels can be multiplied. The SO-DIMM connector is electrically connected with the chipset, the first graphic interface, several second graphic interfaces. The fourth channels are between the SO-DIMM connector and the corresponding second graphic interfaces, for electrically connecting the SO-DIMM connector and the corresponding second graphic interfaces. The first transmission mode is entered when the SO-DIMM connector and the adapter are electrically connected with the chipset and the first graphic interface, and the second transmission mode is entered when the SO-DIMM connector and the adapter are electrically connected with the chipset, the first graphic interface and several second graphic interfaces.

The motherboard according to the preferred embodiment of the invention provides transmission modes shiftable on user's demand. The motherboard has a graphic interface with N lanes for being inserted by one graphic card under the first transmission mode and has two graphic interfaces with lanes add up to N for being inserted by two graphic card simultaneously under the second transmission mode. This invention not only increases the flexibility of usage and highly enhances the operation performance due to the parallel processing of two graphic interfaces. Besides, the motherboard according to the invention can provide n graphic interfaces with Mi lanes for being inserted by n graphic cards simultaneously, where i=1˜n and ΣMi (i=1˜n)=N. This invention introduces the SO-DIMM connector, which has been widely used in the memory module, so as to reduce the manufacturing cost and lowering the threshold of design. Therefore, the motherboard according to the invention becomes very competitive in the marketplace.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A motherboard having a first transmission mode and a second transmission mode, the motherboard comprising:
a chipset;
a first graphic interface;
a second graphic interface;
a Small-Outline Dual-Inside Memory Modules (SO-DIMM) connector, electrically connected with the chipset, the first graphic interface, and the second graphic interface respectively; and
an adapter electrically connected with the SO-DIMM connector, for shifting the first transmission mode and the second transmission mode;
wherein the first transmission mode is entered when the SO-DIMM connector and the adapter are electrically connected with the chipset and the first graphic interface, and the second transmission mode is entered when the SO-DIMM connector and the adapter are electrically connected with the chipset, the first graphic interface and the second graphic interface.

2. The motherboard according to claim 1, wherein the adapter comprises a first circuit and a second circuit, wherein when the adapter is electrically connected with the SO-DIMM connector by way of the first circuit, the motherboard enters the first transmission mode; and wherein when the adapter is electrically connected with the SO-DIMM connector by way of the second circuit, the motherboards enters the second transmission mode.

3. The motherboard according to claim 1 further comprising:
a first channel between the chipset and the first graphic interface, for electrically connecting the chipset and the first graphic interface;
a second channel between the chipset and the SO-DIMM connector, for electrically connecting the chipset and the SO-DIMM connector;
a third channel between the SO-DIMM connector and the first graphic interface, for electrically connecting the SO-DIMM connector and the first graphic interface; and
a fourth channel between the SO-DIMM connector and the second graphic interface, for electrically connecting the SO-DIMM connector and the second graphic interface.

4. The motherboard according to claim 3, wherein the chipset comprises a plurality of chipset front lanes and a plurality of chipset back lanes adjacent thereto, the first graphic interface comprises a plurality of first-graphic-interface front lanes and a first-graphic-interface back lanes adjacent thereto, and the chipset front lanes and the first-graphic-interface front lanes form the first channel between the chipset and the first graphic interface.

5. The motherboard according to claim 4, wherein when the SO-DIMM connector is connected with the chipset and the first graphic interface, the second channel is formed by the SO-DIMM connector and the chipset back lanes, and the third channel is formed by the SO-DIMM connector and the first-graphic-interface back lanes.

6. The motherboard according to claim 5, wherein the first channel, the second channel, and the third channel are electrically connected under the first transmission mode.

7. The motherboard according to claim 5, wherein the second graphic interface comprises a plurality of second-graphic-interface front lanes, and wherein when the SO-DIMM connector electrically connects the chipset and the second graphic interface, the SO-DIMM connector, the second channel is formed by the SO-DIMM connector and the chipset back lanes and the fourth channel is formed by the SO-DIMM connector and the second-graphic-interface front lanes.

8. The motherboard according to claim 7, wherein the first channel, the second channel, and the fourth channel are electrically connected under the second transmission mode.

9. The motherboard according to claim 8, wherein the first graphic interface is inserted with a graphic card under the first transmission mode.

10. The motherboard according to claim 9, wherein the first graphic interface is a PCI Express X16 graphic interface under the first transmission mode.

11. The motherboard according to claim 1, wherein the first graphic interface and second graphic interface are respectively inserted with a first graphic card and a second graphic card under the second transmission mode.

12. The motherboard according to claim 9, wherein the first graphic interface and the second graphic interface are two PCI Express X8 graphic interfaces under the second transmission mode.

13. A motherboard having a first transmission mode and a second transmission mode, the motherboard comprising:
a chipset;
a first graphic interface;
a plurality of second graphic interfaces;
a Small-Outline Dual-Inside Memory Modules (SO-DIMM) connector, electrically connected with the chipset, the first graphic interface and the second graphic interfaces respectively; and
an adapter electrically connected with the SO-DIMM connector, for shifting the first transmission mode and the second transmission;
wherein the first transmission mode is entered when the SO-DIMM connector and the adapter are electrically connected with the chipset and the first graphic interface, and the second transmission mode is entered when the SO-DIMM connector and the adapter are electrically connected with the chipset, the first graphic interface and the second graphic interfaces.

14. The motherboard according to claim 13, wherein the adapter comprises a first circuit and a second circuit; wherein when the adapter is electrically connected with the SO-DIMM connector by way of the first circuit, the motherboard enters the first transmission mode; and wherein when the adapter is electrically connected with the SO-DIMM connector by way of the second circuit, the motherboards enters the second transmission mode.

15. The motherboard according to claim 13 further comprising:
a first channel between the chipset and the first graphic interface, for electrically connecting the chipset and the first graphic interface;
a second channel between the chipset and the SO-DIMM connector, for electrically connecting the chipset and the SO-DIMM connector;
a third channel between the SO-DIMM connector and the first graphic interface, for electrically connecting the SO-DIMM connector and the first graphic interface; and
a plurality of fourth channels between the SO-DIMM connector and the corresponding second graphic interfaces, for electrically connecting the SO-DIMM connector and the corresponding second graphic interfaces.

16. The motherboard according to claim 15, wherein the chipset comprises:
a plurality of chipset front lanes, corresponding to the first channel; and
a plurality of chipset back lanes, adjacent to the plurality of chipset front lanes and corresponding to the second channel.

17. The motherboard according to claim 16, wherein the first channel, the second channel, and the third channel are electrically connected under the first transmission mode.

18. The motherboard according to claim 17, wherein the first channel, the second channel, and the fourth channel are electrically connected under the second transmission mode.

19. The motherboard according to claim 18, wherein the first graphic interface is inserted with a graphic card under the first transmission mode.

20. The motherboard according to claim 19, wherein the first graphic interface and the second graphic interfaces are respectively inserted with a first graphic card and a plurality of second graphic cards under the second transmission mode.
